(19) United States
(12) Patent Application Publication
(10) Pub. No.: US 2007/0128403 A1
(43) Pub. Date: Jun. 7, 2007

(54) Composite shoe insole

(76) Inventor: Kuo-Nan Yang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/294,592

(22) Filed: Dec. 5, 2005

(51) Int. Cl. B44C 1/26

(52) U.S. Cl. 428/67; 428/137

(57) ABSTRACT

A composite shoe insole includes an EVA material having at least one bonding zone, and at least one PU material mounted in the bonding zone of the EVA material. Thus, the composite shoe insole closely combine the EVA material with the PU material, so that the composite shoe insole has a lighter weight by the EVA material and has a soft elastic feature by the PU material.

### BACKGROUND OF THE INVENTION

1. Field of the Invention

The present invention relates to a shoe insole and, more particularly, to a composite shoe insole.

2. Description of the Related Art

A conventional shoe insole is made of PU material that has a soft elastic feature to provide a greater elastic support to a user's foot, thereby providing a comfortable sensation to the user. However, the PU material has a heavier weight, thereby increasing the burden to the user. In addition, the PU material easily produces powder when touching the water, thereby weakening or breaking the structure of the shoe insole.

Another conventional shoe insole is made of EVA material that has a lighter weight so as to reduce the whole weight of the shoe insole, thereby decreasing the burden to the user. However, the EVA material has a smaller elasticity, thereby easily causing an uncomfortable sensation to the user.

### SUMMARY OF THE INVENTION

In accordance with the present invention, there is provided a composite shoe insole, comprising an EVA material having at least one bonding zone, and at least one PU material mounted in the bonding zone of the EVA material.

The primary objective of the present invention is to provide a composite shoe insole that closely combine the EVA material with the PU material, so that the composite shoe insole has a lighter weight by the EVA material and has a soft elastic feature by the PU material.

Another objective of the present invention is to provide a composite shoe insole, wherein the solid PU material of the shoe insole provides a greater elastic support to a user's foot, thereby providing a comfortable sensation to the user.

A further objective of the present invention is to provide a composite shoe insole, wherein the EVA material of the shoe insole has a lighter weight to reduce the whole weight of the shoe insole, thereby decreasing the burden to the user.

A further objective of the present invention is to provide a composite shoe insole, wherein the proportion, position and size of the EVA material and the PU material can be changed according to the practical requirement so as to provide a comfortable sensation to the user and to reduce the whole weight of the shoe insole, thereby enhancing the versatility of the shoe insole.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a composite shoe insole in accordance with the preferred embodiment of the present invention.

FIG. 2 is a plan cross-sectional assembly view of the composite shoe insole as shown in FIG. 1.

FIG. 3 is an exploded perspective view of a composite shoe insole in accordance with another preferred embodiment of the present invention.

FIG. 4 is a plan cross-sectional assembly view of the composite shoe insole as shown in FIG. 3.

FIG. 5 is an exploded perspective view of a composite shoe insole in accordance with another preferred embodiment of the present invention.

FIG. 6 is a plan cross-sectional assembly view of the composite shoe insole as shown in FIG. 5.

FIG. 7 is an exploded perspective view of a composite shoe insole in accordance with another preferred embodiment of the present invention.

FIG. 8 is a plan cross-sectional assembly view of the composite shoe insole as shown in FIG. 7.

### DETAILED DESCRIPTION OF THE INVENTION

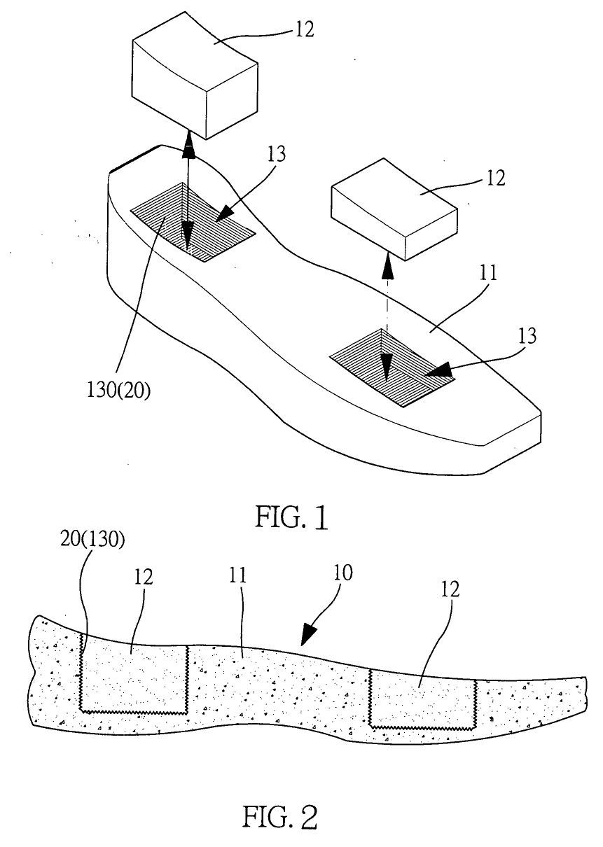

Referring to the drawings and initially to FIGS. 1 and 2, a composite shoe insole 10 in accordance with the preferred embodiment of the present invention comprises an EVA (ethyl vinyl acetate) material 11 having at least one bonding zone 13, at least one PU (polyurethane) material 12 mounted in the bonding zone 13 of the EVA material 11, and a PU film 20 mounted between the PU material 12 and the bonding zone 13 of the EVA material 11. Thus, the PU material 12 is closely combined with the bonding zone 13 of the EVA material 11 by the PU film 20 to form the shoe insole 10.

In the preferred embodiment of the present invention, the PU film 20 is coated around a peripheral wall of the bonding zone 13 of the EVA material 11. Preferably, the peripheral wall of the bonding zone 13 of the EVA material 11 has a rough surface 130, and the PU film 20 is applied onto the rough surface 130 of the bonding zone 13 of the EVA material 11.

Thus, the PU material 12 is combined with the bonding zone 13 of the EVA material 11 by the PU film 20 which functions as a bonding interface between the PU material 12 and the bonding zone 13 of the EVA material 11, so that the PU material 12 is combined with the EVA material 11 closely.

In addition, the bonding zone 13 is a recess which is formed in an inside of the EVA material 11 and is not extended through a whole thickness of the EVA material 11 as shown in FIG. 2.

Preferably, the EVA material 11 has two substantially rectangular bonding zones 13 located at front and rear portions of the EVA material 11 respectively, and the composite shoe insole 10 comprises two solid PU materials 12 mounted in the bonding zones 13 of the EVA material 11 so that the two solid PU materials 12 are located at the front and rear portions of the EVA material 11 respectively.

Thus, the two solid PU materials 12 of the shoe insole 10 provide a greater elastic support to the front and rear portions of a user's foot, thereby providing a comfortable sensation to the user. In addition, the EVA material 11 of the shoe insole 10 has a lighter weight to reduce the whole weight of the shoe insole 10, thereby decreasing the burden to the user.

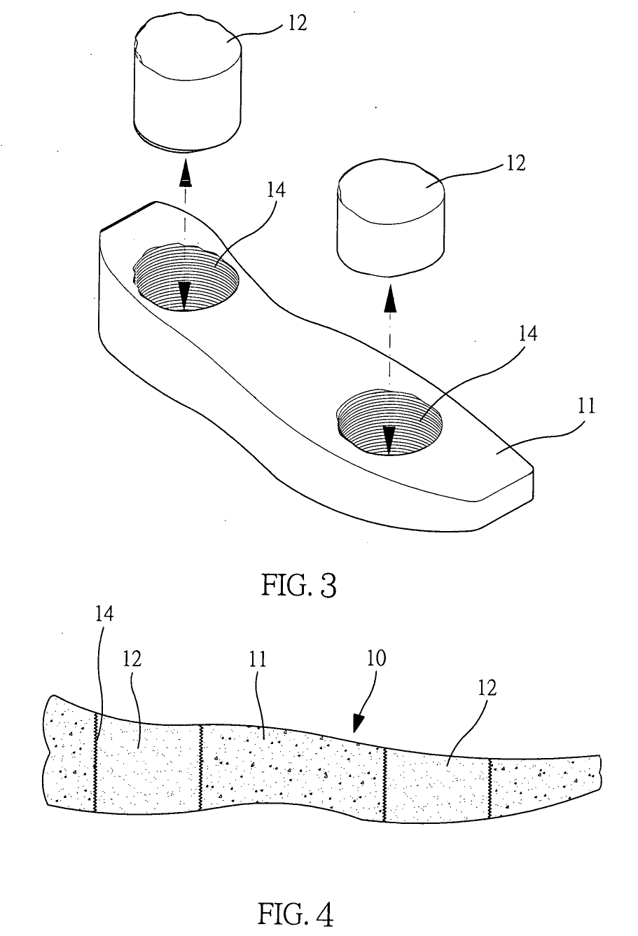

As shown in FIGS. 3 and 4, the bonding zone 14 is a through hole which is formed in an inside of the EVA material 11 and is extended through a whole thickness of the EVA material 11 as shown in FIG. 4. Preferably, the EVA material 11 has two substantially circular bonding zones 14 located at front and rear portions of the EVA material 11 respectively, and the composite shoe insole 10 comprises two solid PU materials 12 mounted in the bonding zones 14 of the EVA material 11 so that the two solid PU materials 12 are located at the front and rear portions of the EVA material 11 respectively.

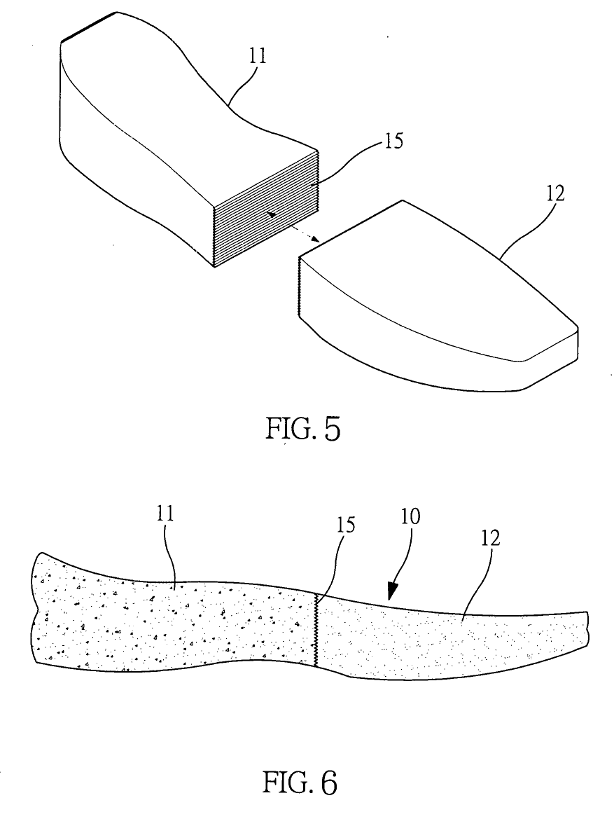

As shown in FIGS. 5 and 6, the bonding zone 15 is a transverse face which is formed on an end portion of the EVA material 11 and is extended through a whole thickness of the EVA material 11. Preferably, the EVA material 11 has a bonding zone 15 located at a rear portion of the EVA material 11, so that a solid PU material 12 is located at the rear portion of the EVA material 11.

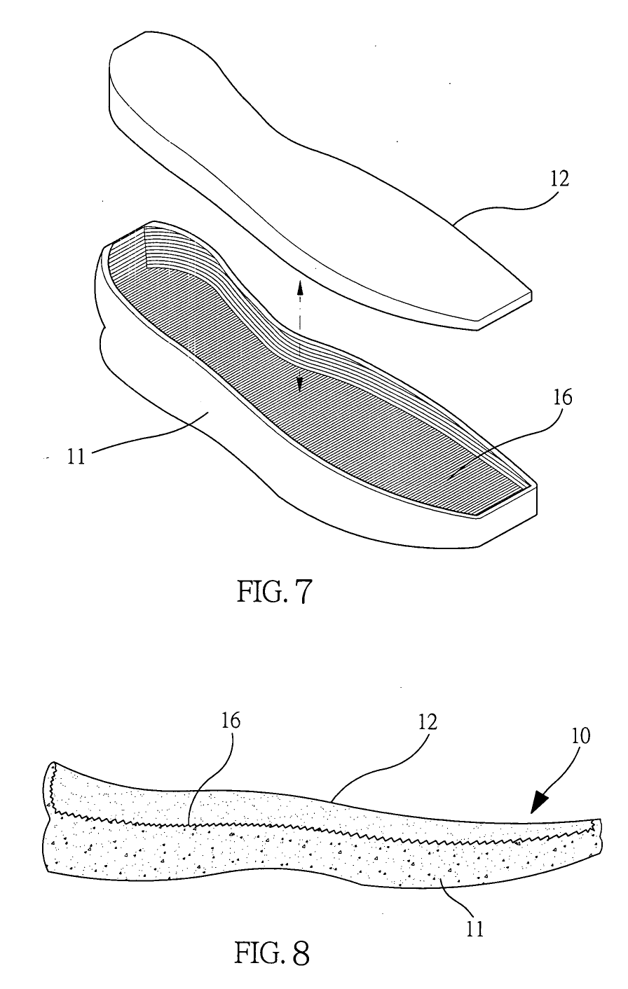

As shown in FIGS. 7 and 8, the bonding zone 16 is a groove which is formed in an inside of the EVA material 11 and is approximately extended through a whole length of the EVA material 11. Preferably, the EVA material 11 has a bonding zone 16 extended from a front portion to a rear portion of the EVA material 11, so that a solid PU material 12 is extended from the front portion to the rear portion of the EVA material 11.

Accordingly, the solid PU material of the shoe insole provides a greater elastic support to a user's foot, thereby providing a comfortable sensation to the user. In addition, the EVA material of the shoe insole has a lighter weight to reduce the whole weight of the shoe insole, thereby decreasing the burden to the user. Further, the proportion, position and size of the EVA material and the PU material can be changed according to the practical requirement so as to provide a comfortable sensation to the user and to reduce the whole weight of the shoe insole, thereby enhancing the versatility of the shoe insole.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A composite shoe insole, comprising:
an EVA (ethyl vinyl acetate) material having at least one bonding zone;
at least one PU (polyurethane) material mounted in the bonding zone of the EVA material.

2. The composite shoe insole in accordance with claim 1, further comprising a PU film mounted between the PU material and the bonding zone of the EVA material.

3. The composite shoe insole in accordance with claim 2, wherein the PU material is closely combined with the bonding zone of the EVA material by the PU film to form the shoe insole.

4. The composite shoe insole in accordance with claim 2, wherein the PU film is coated around a peripheral wall of the bonding zone of the EVA material.

5. The composite shoe insole in accordance with claim 4, wherein the peripheral wall of the bonding zone of the EVA material has a rough surface, and the PU film is applied onto the rough surface of the bonding zone of the EVA material.

6. The composite shoe insole in accordance with claim 2, wherein the PU material is combined with the bonding zone of the EVA material by the PU film which functions as a bonding interface between the PU material and the bonding zone of the EVA material, so that the PU material is combined with the EVA material closely.

7. The composite shoe insole in accordance with claim 1, wherein the bonding zone is a recess which is formed in an inside of the EVA material.

8. The composite shoe insole in accordance with claim 7, wherein the recess is not extended through a whole thickness of the EVA material.

9. The composite shoe insole in accordance with claim 1, wherein the EVA material has two bonding zones located at front and rear portions of the EVA material respectively, and the composite shoe insole comprises two solid PU materials mounted in the bonding zones of the EVA material so that the two solid PU materials are located at the front and rear portions of the EVA material respectively.

10. The composite shoe insole in accordance with claim 1, wherein the bonding zone is a through hole which is formed in an inside of the EVA material.

11. The composite shoe insole in accordance with claim 10, wherein the through hole is extended through a whole thickness of the EVA material.

12. The composite shoe insole in accordance with claim 1, wherein the bonding zone is a transverse face which is formed on an end portion of the EVA material.

13. The composite shoe insole in accordance with claim 12, wherein the transverse face is extended through a whole thickness of the EVA material.

14. The composite shoe insole in accordance with claim 1, wherein the EVA material has a bonding zone located at a rear portion of the EVA material, so that the solid PU material is located at the rear portion of the EVA material.

15. The composite shoe insole in accordance with claim 1, wherein the bonding zone is a groove which is formed in an inside of the EVA material.

16. The composite shoe insole in accordance with claim 15, wherein the groove is approximately extended through a whole length of the EVA material.

17. The composite shoe insole in accordance with claim 1, wherein the EVA material has a bonding zone extended from a front portion to a rear portion of the EVA material, so that the solid PU material is extended from the front portion to the rear portion of the EVA material.

18. The composite shoe insole in accordance with claim 1, wherein a proportion of the EVA material and the PU material is changeable.
